(19) United States
(12) Patent Application Publication
(10) Pub. No.: US 2005/0254187 A1
(43) Pub. Date: Nov. 17, 2005

(54) Arc fault circuit interrupter

(75) Inventor: Raymond Chu, Chaiwan (HK)

Correspondence Address: MERCHANT & GOULD PC, P.O. BOX 2903, MINNEAPOLIS, MN, 55402-0903, US

(73) Assignee: DEFOND COMPONENTS LIMITED, Chaiwan (HK)

(21) Appl. No.: 10/843,106

(22) Filed: May 11, 2004

(51) Int. Cl. H02H 3/00

(52) U.S. Cl. 361/42

(57) ABSTRACT

An apparatus and method for event-based detection of arc faults in a circuit. At least one sensor is arranged to sense anomaly events in an electrical signal in the circuit. The anomaly events include distortions of the waveform of the electrical signal. A processor identifies the anomaly events, and generates an alarm signal when the anomaly events are indicative of an arc fault. The anomaly events may include current waveform distortions and/or voltage waveform distortions. Waveform distortions may be measured indirectly; an impedance may be placed in series with the circuit, so that distortions of the current produces distortions in the voltage drop across the impedance, in which case those voltage distortions may be anomaly events. Arc faults may be identified by examining intervals such as individual AC cycles for anomaly events, then determining whether at least n of a moving series of m intervals include at least p such anomaly events. An actuator may be used to oppose any arc faults that are detected, such as a circuit breaker to interrupt the circuit, so as to provide arc fault protection. Existing circuits may be retrofitted with the sensor and processor for arc fault detection, along with an actuator for arc fault protection.

### FIELD OF THE INVENTION

The invention relates to an apparatus and method for protecting a circuit from arc faults.

The invention relates more particularly to an arc fault detector that analyzes a voltage drop across an impedance in series with a circuit to determine whether an electrical waveform therein is distorted in such a way as to be indicative of an arc fault.

### BACKGROUND OF THE INVENTION

Electrical arcing is a phenomenon wherein electricity discharges from one point to another across a gap, typically accompanied by a luminous visible spark. Insulating materials and/or a large distance between the two points may inhibit arcing, but with a sufficient voltage differential arcing can occur even when the gap is wide and/or heavily insulated.

Electrical arcing may be expected as part of normal operation for some circuits. For example, arcing commonly occurs in electrical devices when switches open or close, when the devices are plugged in or unplugged (or otherwise connected to or disconnected from a power source), etc. Taking this into account, circuits may be designed to safely accommodate such “normal” arcing.

Undesirable or unanticipated arcing is often referred to as an arc fault. Arc faults can cause damage to electrical circuits, as well as to nearby objects. Under some conditions, arc faults also may present a danger of a shock to persons nearby. In addition, because arcing can generate extremely high temperatures, arc faults may pose a fire hazard.

Common types of arc faults include series arc faults (sometimes referred to as “contact arc faults”), parallel arc faults (sometimes referred to as “line arc faults”), and ground arc faults. Though they may occur at different locations, the physical phenomenon is essentially the same for all three of these types.

An exemplary series arc fault is illustrated in FIG. 1. In a series arc fault, arcing occurs between two contact points in series with a load. FIG. 1 shows a portion of an electrical circuit 10 with conductors 12 and 14. Conductor 12 has a break therein, forming contact points 16 and 18. An arc 20 may form between the contact points 16, 18. This arc may produce rapid variations in the current and voltage delivered to the load (not shown), and so may damage the load, the power supply (not shown), etc. It may also further damage the conductors 16 and 18. In addition, heat from the arcing may damage the insulation 22. Even if the insulation 22 itself is non-flammable, if it is ruptured subsequent arcing may ignite other nearby substances.

An exemplary parallel arc fault is illustrated in FIG. 2. In a parallel arc fault, arcing occurs between two contact points on two different conductors within the circuit. FIG. 2 shows a portion of an electrical circuit 30 with conductors 32 and 34. The insulation 42 between the conductors 32, 34 has a break therein, exposing contact points 36 and 38 on conductors 32 and 34, respectively. An arc 40 may form between the contact points 36, 38, posing potential problems similar to those already described.

An exemplary ground arc fault is illustrated in FIG. 3. In a ground arc fault, arcing occurs between a contact point on a conductor within the circuit and some grounded object. FIG. 3 shows a portion of an electrical circuit 50 with conductors 52 and 54. The insulation 62 enclosing conductor 52 has a break therein, exposing contact point 56. An arc 60 may form between the contact point 56 on conductor 52 and a ground contact 64.

Arcing exhibits a number of characteristic features. Typically, when a circuit arcs there are changes in the levels of current and voltage applied to the load. Conventional arc fault detection relies on measuring overall properties of the electrical signal in a circuit, and identifying changes in those properties.

For example, conventionally arcing has been detected by observing the current and/or voltage levels of the electrical signal. With this arrangement, a significant increase or decrease in the levels may be considered to be an indication of an arc fault.

However, such arrangements are not entirely satisfactory, at least in part because of the nature of arc fault signals.

Arc fault signals conventionally are very difficult to isolate, at least in part because the arc fault signal represents only a portion of the total electrical current and voltage levels within the circuit. For example, currents within an electrical circuit also include a power supply current, that is, the load or “base” AC or DC current that is being routed through the circuit. In addition, other components may contribute to the current within the circuit continuously and/or intermittently. For example, mechanical switching, relay switching, activation/deactivation of load devices, etc. may be present within the circuit. The time at which such events occur may be highly variable, and so the incidence of such changes can be difficult to predict.

Similarly, the voltage signature of an arc fault may be complex, since the voltage applied to a load may vary for a number of reasons. For example, the voltage in an AC circuit typically varies at a frequency of 50 Hz or 60 Hz. In addition, activating and deactivating various systems or components of the load may change the voltage levels, at least temporarily. Changes in voltage levels also may be relatively random and unpredictable.

Because the voltage and current in a circuit may vary substantially over time even without an arc fault, reliably measuring the voltage and current levels for a given circuit may be difficult. Thus, reliably determining whether an arc fault is present based on such conventional approaches likewise may be difficult. In particular, events other than arc faults may be interpreted as arc faults, so that the likelihood of a false alarm may be high.

In addition, conventional approaches for measurement may themselves be less than ideal.

For example, conventional arc fault detection utilizes one or more low ohm resistors arranged in series with the circuit to be protected. FIG. 4 shows an exemplary conventional arrangement. A portion of a circuit 70 includes conductors 72 and 74, insulated from one another and from outside contacts by an insulator 82.

A low ohm resistor 88 is placed in series with one conductor 72 of the circuit. The magnitude of the voltage is measured at contact points 90 at either end of the resistor 88. In accordance with Ohm's Law, the voltage drop across the resistor 88 varies proportionally with the current passing through the resistor 88. Thus, as the current passing through the resistor 88 fluctuates, such as during arcing, the voltage difference between the contacts 90 also will fluctuate. Measurement of the magnitude of the voltage drop thus can be used to determine, indirectly, the current passing through the resistor 88.

However, for a current passing through a resistor 88, the power lost as heat in that resistor 88 is directly proportional to its resistance. Thus, incorporating a series resistor into a circuit for purposes of arc fault detection results in a transformation of electrical power into heat in that resistor 88. This increases both the power required and the heat generated when the circuit operates. Therefore, in order to avoid excessive power loss and waste heat generation, the resistor 88 generally should have as small a resistance as is feasible.

However, as the resistance of the resistor 88 decreases, so too does the magnitude of the voltage difference between the contacts 90. The smaller the resistance, the more difficult it is to effectively measure the magnitude of the voltage drop across it. Thus, there are two mutually opposing requirements in the conventional design.

Conventionally, the difficulty in measuring a voltage difference of small magnitude between the contacts 90 of a conventional arc fault detector has been addressed by incorporating amplifiers into the circuit, to amplify the magnitude of the voltage difference between the contacts 90. However, as the resistance of the resistor 88 decreases—which as previously noted is desirable—the amplification required increases. The relatively powerful amplifiers necessary for many conventional arc fault detectors tend to be expensive and complicated.

Furthermore, the amplified signal includes not only the voltage drop associated with arcing, but also the voltage drop from the load and any other signals that may be present. Effectively, these other signals constitute noise, potentially obscuring any arc faults that may be present. Conventional arc fault detectors thus must include circuitry to capture the arc signals only, i.e. only that portion of the magnitude of the voltage drop that is caused by the arc fault signal. This is made more difficult by the fact that, for many applications, the load signal is at least of the same order of magnitude as an expected arc signal, and may be larger.

As a result, conventional arc fault detectors typically utilize complex circuit arrangements to separate arc fault signals from any other signals. These circuits generally are difficult to design, and also often are expensive.

In addition, retrofitting existing circuits with arc fault detection capability is difficult with conventional devices and methods. The difficulty of designing and constructing a suitable capture circuit, the need for powerful amplifiers, and the additional power draw and heat generation associated with the resistor in a conventional system all complicate the process of retrofitting existing circuits using conventional approaches. This disadvantage may be even more significant over time, as there appears to be a trend in existing and forthcoming electrical standards to demand effective arc fault protection in an increasing number of electrical devices.

### SUMMARY OF THE INVENTION

It is the purpose of the claimed invention to overcome these difficulties, thereby providing an improved apparatus and method for detecting arc faults.

An exemplary embodiment of an arc fault detector in accordance with the principles of the present invention includes at least one sensor in communication with a circuit so as to sense anomaly events in the electrical signal in that circuit. The anomaly events include distortions of the electrical signal. The arc fault detector also includes a processor in communication with the sensor so as to identify the anomaly events, and to generate an alarm signal when the anomaly events are indicative of an arc fault in the circuit.

The sensor of the arc fault detector may include a voltage sensor monitoring the waveform of the voltage applied to the circuit. The anomaly events likewise may include distortions of the applied voltage waveform.

The sensor of the arc fault detector may include a current sensor. The anomaly events may include distortions of the current waveform.

The processor may identify the anomaly events during intervals of the signal, and classify the intervals as event intervals if at least p anomaly events are identified during the intervals, p being a positive integer, and otherwise classifying the intervals as non-events. The processor may store event classifications for m consecutive intervals, m being a positive integer. The processor may generate the alarm signal if at least n of m consecutive intervals are event intervals, n being a positive integer less than or equal to m.

The circuit may be an AC circuit, and the intervals may include at least one AC cycle.

An exemplary embodiment of an arc fault protector in accordance with the principles of the present invention includes an arc fault detector as described above, and an actuator in communication with the processor, the actuator opposing the arc fault in the circuit upon receiving the alarm signal.

The actuator may interrupt the circuit upon receiving the alarm signal.

The actuator may include a circuit breaker.

An exemplary embodiment of a kit in accordance with the principles of the present invention for retrofitting a circuit for arc fault detection includes at least one sensor adapted to be arranged in communication with a circuit, for sensing anomaly events in an electrical signal in the circuit. The kit also includes a processor adapted to identify the anomaly events in the electrical signal, and to generate an alarm signal when the anomaly events are indicative of an arc fault in the circuit.

The sensor may include a voltage sensor adapted to be in communication with the circuit so as to monitor the voltage applied to the circuit.

The kit may include instructions for retrofitting the circuit.

An exemplary embodiment of a method of detecting an arc fault in a circuit in accordance with the principles of the present invention includes sensing anomaly events in an electrical signal in the circuit, and interpreting the anomaly events to determine a presence of an arc fault in the circuit. The anomaly events include distortions of the waveform of the electrical signal.

The anomaly events may include waveform distortions of the voltage applied to the circuit.

The anomaly events may include waveform distortions of the current in the circuit.

Interpreting the anomaly events may include associating the anomaly events with intervals of the electrical signal, classifying those intervals as event intervals if at least p anomaly events are identified during the intervals, p being a positive integer, and otherwise classifying those intervals as non-events. Interpretation also may include storing event classifications for m consecutive intervals, m being a positive integer, and generating the alarm signal if at least n of the m consecutive intervals are event intervals, n being a positive integer less than or equal to m.

The circuit may be an AC circuit, and the intervals may include at least one AC cycle.

An exemplary method of protecting a circuit from arc fault in accordance with the principles of the present invention includes detecting an arc fault as described above, and opposing the arc fault.

Opposing the arc fault may include interrupting the circuit.

An exemplary method of interpreting an electrical signal in accordance with the principles of the present invention in order to detect an arc fault includes identifying anomaly events in the electrical signal during intervals. The intervals are classified as event intervals if at least p anomaly events are identified during the intervals, p being a positive integer, otherwise the intervals are classified as non-events. The event classifications for m consecutive intervals are stored, m being a positive integer, and an arc fault is indicated if at least n of the m consecutive intervals are event intervals, n being a positive integer less than or equal to m.

### BRIEF DESCRIPTION OF THE DRAWINGS

Like reference numbers generally indicate corresponding elements in the figures.

FIG. 1 is a representation of series arcing, as known from the prior art.

FIG. 2 is a representation of parallel arcing, as known from the prior art.

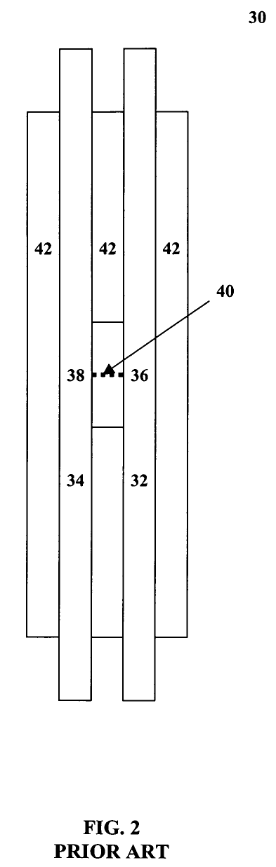

FIG. 3 is a representation of ground arcing, as known from the prior art.

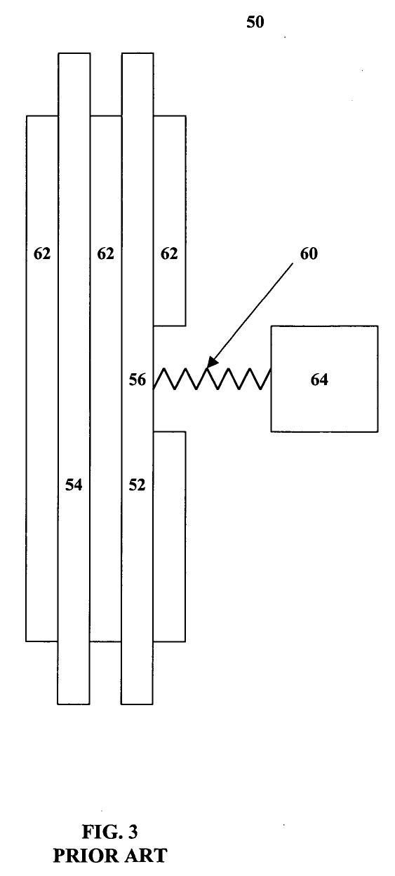

FIG. 4 is a representation of a low ohm resistor arrangement for arc fault detection, as known from the prior art.

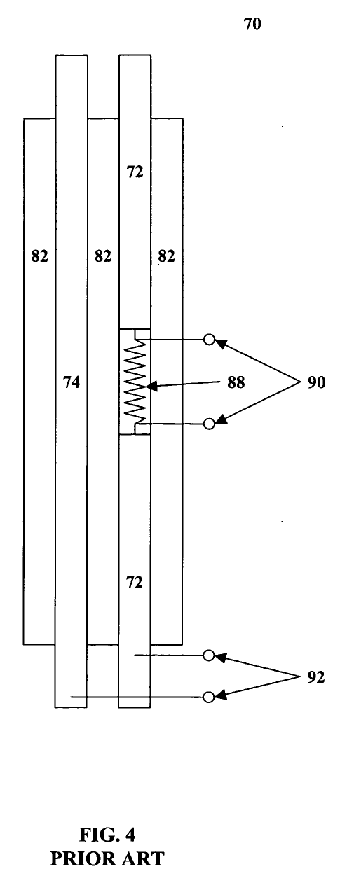

FIG. 5 is a block view of an exemplary embodiment of an apparatus for arc fault detection in accordance with the principles of the claimed invention.

FIG. 6 is a block view of an exemplary embodiment of an apparatus for arc fault protection in accordance with the principles of the claimed invention.

FIG. 7 is a circuit schematic for an exemplary embodiment of an apparatus for arc fault protection in accordance with the principles of the claimed invention.

FIG. 8 is a representation of waveforms for an electrical signal, including a sinusoidal wave, a high voltage clipped wave, and a low voltage clipped wave.

### DETAILED DESCRIPTION OF THE PREFERRED EMBODIMENT

As a preliminary matter, a general comment regarding the approach for arc fault detection in the present invention as compared with conventional approaches may be helpful.

As previously described, conventional approaches to arc fault detection typically rely upon monitoring the general conditions of electrical signals within a circuit, such as the magnitude of the voltage, the magnitude of the current, or the frequency of the signal. Such a conventional approach may be referred to as condition-based detection.

By contrast, the present invention uses event-based detection to identify arc faults, in addition to or in place of conventional condition-based detection. That is, the present invention identifies anomaly events that take place in a signal. More particularly, the invention identifies anomaly events in the form of distortions to an electrical signal. For example, as is described in greater detail below, distorted AC voltage or current wave cycles may be detected.

Detection of signal distortion in voltage or current is not necessarily equivalent to measurement of the voltage or current per se as in conventional condition-based detection. For example, a signal may be distorted without necessarily changing its magnitude. Thus, measurement of for example the current magnitude does not imply detection of a distorted current wave cycle. Conversely, detection of a distorted current wave cycle does not imply the measurement of the magnitude of the current, since it may not be necessary to actually measure the value of the current at any point in order to note the distortion.

In short, condition measurement and event detection are different processes; condition measurement does not necessarily imply or include event detection, nor vice versa. The arrangements of the present invention for event detection of arc faults are described in greater detail below.

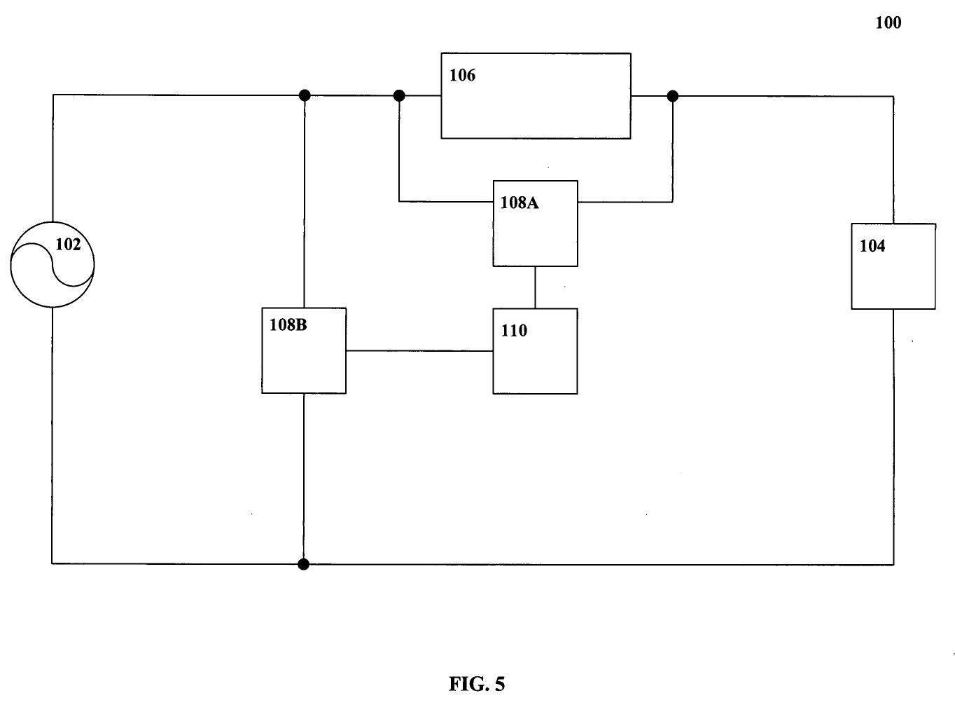

A block diagram of a circuit 100 including an exemplary apparatus for detecting arc faults in accordance with the principles of the present invention is shown in FIG. 5.

As shown, the circuit 100 includes a electrical source 102 and an electrical load 104. In the embodiment illustrated, the electrical source 102 is an AC source. AC power sources, such as 120 volt 50/60 cycle “wall” output, are widely used. However, the present invention is not limited only to use with circuits utilizing a common 120 volt 50/60 cycle electrical source 102; it may be equally suitable for use with a wide variety of circuits, regardless of the specifics of their electrical power source.

Electrical power sources 102 are known per se, and are not described further herein.

Similarly, the present invention is not limited to use with a particular type of electrical load 104. Rather, it may be suitable for use with substantially any electrical load. Electrical loads 104 also are known per se, and are not described further herein.

An arc fault detector in accordance with the principles of the present invention includes at least one sensor 108 in communication with the circuit 100. The type of sensor(s) 108 may vary considerably, as described in greater detail below. However, the sensor 108 is adapted to sense anomaly events in an electrical signal within the circuit.

As previously described, event-based detection of arc faults is very different from condition-based detection, in that event-based detection relies upon sensing and identifying individual events in an electrical signal, rather than upon measuring overall characteristics of an electrical signal.

The type of events that may be relied upon for arc fault detection may vary considerably depending upon the specific sensor(s) 108 used, as well as on the particulars of the circuit wherein arc faults are to be detected. Examples of suitable events are described below. However, for general purposes, such events are referred to as anomaly events.

As the term is used herein, an anomaly event is an event in an electrical signal that may be produced by or concurrently with an arc fault. However, anomaly events are not themselves arc faults. For example, anomaly events may be produced by other phenomena, with or without the presence of an arc fault. By sensing and interpreting those anomaly events, however, it is possible to distinguish between actual arc faults and common false alarm sources.

The exemplary arrangement in FIG. 5 shows several sensors that may be used for detecting several different types of anomaly events. A current sensor 108A, for example, may be used to identify the presence of distortions in the current flowing through the circuit 100.

It is noted that reference to a “current sensor” herein does not necessarily imply that current is being sensed directly. For example, in the arrangement shown in FIG. 5, the sensor 108A may actually be sensing voltage in order to determine the current. Such an arrangement may be as follows.

As shown in FIG. 5, the present invention may include an impedance 106 disposed in the circuit 100 in series with the load 104. In accordance with Ohm's Law, the voltage drop across an impedance is determined as V=IZ, wherein V is the voltage drop, I is the current, and Z is the impedance. Consequently, the voltage drop across the impedance 106 is proportional to the current flowing through it. As a result, as the current changes, the voltage drop across the impedance 106 will change.

Distortion of the waveform of current flowing through the impedance 106 thus will manifest as distortion of the voltage drop across the impedance 106.

It is noted that such voltage changes typically will manifest regardless of the actual value of the voltage drop across the impedance 106, or the magnitude of the current in the circuit 100. Thus, it may not be necessary to know or measure the levels of either the current or the voltage drop in order to sense the presence of distortion in the current waveform.

In a simple arrangement, the impedance 106 may include a resistor. In a case wherein the impedance 106 is entirely resistive, Ohm's Law may be restated more familiarly as V=IR, wherein R is the resistance. In such instance, current waveform deformations will manifest as waveform deformations of the voltage drop across the impedance 106.

Impedances 106, including resistors, are known per se, and are not described further herein.

The current sensor 108A is not particularly limited. A wide variety of current sensors 108A may be suitable for use with the present invention.

The term “current sensor” (and similarly, “voltage sensor” as used below) is used herein in a broad sense, to refer to a mechanism for identifying phenomena of interest relating to current. Such a sensor may not necessarily provide actual measurements of current levels at any given time. For example, as noted, current distortions may be detected as anomaly events. A distortions might be identified based on the rate of change of the current (more directly, for an embodiment utilizing an impedance 106, the rate of change of the voltage drop), regardless of the actual current at any point. Thus, in certain embodiments it may be suitable to detect a high rate of change in current, or other features indicative of current distortion, without necessarily measuring the actual current levels.

Even when the current sensor 108A is such that it does measure and track actual current levels over time, the use of the term “sensor” does not imply the use of specific devices, approaches for measurement, displays or outputs, etc.

Sensors, including current sensors, are known per se, and are not described further herein.

Although as described above it may be advantageous to sense distortions in the current waveform indirectly, by detecting distortions in voltage drop across an impedance 106, this is exemplary only. It may be equally suitable to sense current distortions directly, or by different indirect approaches. The current need not be measured at an impedance 106 if an impedance is present, nor is an impedance 106 required for such a current measurement.

FIG. 5 also shows a voltage sensor 108B, arranged so as to sense voltage applied to the load 104. As shown, the voltage sensor 108B is arranged to sense voltage to the impedance 106 in combination with the load 104. For arrangements wherein the impedance 106 is small, and hence the voltage drop across the impedance 106 is small, this may be suitable. However, such an arrangement is exemplary only.

As previously noted, waveform distortions, such as in voltage or current, may be sensed as anomaly events. Exemplary arrangements for this may be as follows.

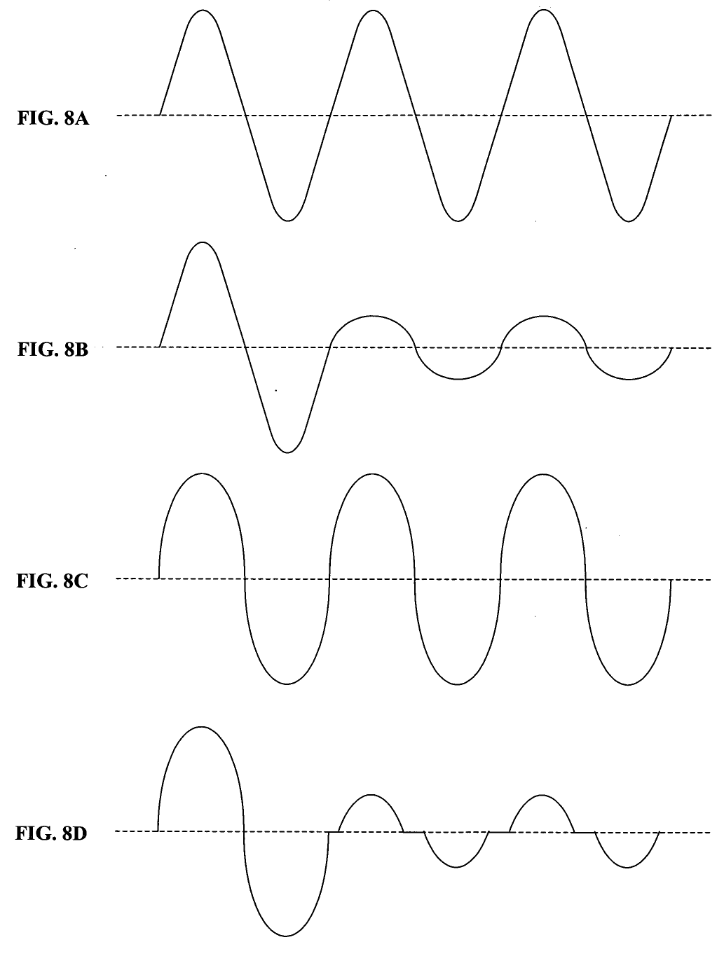

Referring to FIG. 8, FIG. 8A shows a voltage wave, approximating a voltage signal that might be applied to an AC circuit. Certain types of arc faulting may affect the shape of the wave shown in FIG. 8A.

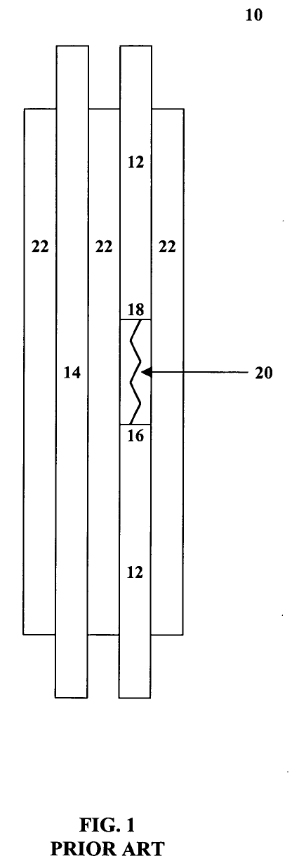

For example, consider the various arc faults illustrated in FIG. 1. As shown therein, arcs may form across a break in a conductors, between conductors, and from a conductor to a ground.

Typically there is a minimum voltage necessary for arcing between two points. If the voltage at the site of arcing equals or exceeds the minimum voltage necessary for arcing, arcing may occur; if the voltage at the site of arcing does not equal the minimum voltage, arcing may not occur.

In an AC signal, the applied voltage varies cyclically with time. A typical non-arc voltage waveform is shown in FIG. 8A. This could be representative of line voltage applied from a wall socket, etc.

Because the voltage varies as shown in FIG. 8A, during some portions of the cycle the voltage may be sufficient to produce arcing, while during other portions of the cycle the voltage may not be sufficient. As a result, the voltage signal that is applied may be distorted.

FIG. 8B shows an example of such a distorted voltage signal. In the exemplary distortion shown, the first wave cycle is identical to those in FIG. 8A. However, at the beginning of the second wave cycle, the voltage waveform changes from a relatively tall, elongated shape to a flatter waveform.

This might occur, for example, if there were a series arc fault such as that shown in FIG. 1 disposed between the electrical source 102 and the load 104. In such circumstances, some of the voltage in the original signal might be dissipated in arcing across the break in the conductor. Thus, the size and/or shape of the waveform that actually is applied to the load may be different from the initial waveform.

Similarly, FIG. 8C shows a typical non-arc current waveform, such as might be representative of line current from a wall socket.

As noted, there may be a minimum voltage necessary for arcing. In addition to producing distortions in the voltage waveform, this may likewise produce distortions in the current waveform. Consider again an arrangement with a series arc fault such as that shown in FIG. 1 disposed between the electrical source 102 and the load 104. During that portion of the AC cycle wherein the voltage is less than the minimum arcing voltage, the break effectively renders the circuit open; no current flows therethrough. When the voltage reaches the minimum necessary for arcing, current may flow through the circuit.

As a result, the current waveform also may be distorted. One possible type of distortion is shown in FIG. 8D. Therein, the current waveform has been “clipped”, so that those parts of the current waveform that correspond to times when the voltage is less than the arcing minimum are lost, i.e. by being unable to pass the break in the conductor).

Arc faults other than series arc faults also may cause distortion of the electrical signal, in terms of current and/or voltage applied to the load. In addition, the forms of electrical signal distortion that may be considered by the present invention in identifying anomaly events are not limited only to those described above and illustrated in FIG. 8. Those forms are exemplary only, and other types of distortion may be equally suitable.

In addition, although for purposes of clarity the signal distortions are shown to be relatively extreme in FIG. 8, it is not necessary for voltage distortions to be as extreme as is shown. More subtle distortions may be equally suitable.

More than one feature of an electrical signal may be considered when identifying some occurrence in that signal as an anomaly event. For example, referring again to FIG. 5, the current sensor 108A is arranged so as to sense the current passing through the impedance 106. Although it is not necessary to measure the magnitude of the current, it also is not prohibited.

Thus, the level of current in the impedance 106 may be measured, and used as a consideration in identifying an anomaly event. In such an arrangement, the current measured within the impedance 106 may be considered to be part of the anomaly event. That is, in order to be identified as an anomaly event for further consideration, distortion in the current waveform might have to be identified concurrently with a certain minimum current level.

Such an arrangement may provide even greater confidence in detecting arc faults. For example, as noted previously, noise signals typically have currents significantly smaller than those of arc faults. Thus, a current distortion produced by a genuine arc fault may be accompanied by a relatively high current, while a current distortion produced by noise may not be accompanied by a high current.

However, although the consideration of multiple features when identifying anomaly events may be advantageous for certain embodiments, it is exemplary only.

As noted above, measurement of the current level is not prohibited. Likewise, measurement of other conditions, as opposed to events, is not prohibited, although it may not be necessary for all embodiments.

Although FIG. 5 shows two sensors, current sensor 108A and voltage sensor 108B, this is exemplary only. Embodiments having one sensor, or more than two sensors, may be equally suitable. For purposes of simplicity, subsequent description generally will refer to the sensor in singular, as a sensor 108.

An arc fault detector in accordance with the principles of the present invention further includes a processor 110. The processor is in communication with the sensor 108, and uses data obtained by the sensor 108 to determine whether an arc fault is present.

The processor 110 also is not particularly limited. Although for clarity the processor 110 is referred to herein as discrete physical device, such as an integrated circuit chip, this is exemplary only. Substantially any mechanism with the necessary processing capability may suitable for use as a processor 110 for the present invention. In particular, it is emphasized that the processor 110 is not necessarily a stand-alone physical device. Rather, in certain embodiments the processor 110 may exist entirely as firmware and/or software on an otherwise unrelated device. For example, the processor 110 might be a computer program loaded into a personal computer, a master control circuit for an electrical device, or another processing device that is not exclusively associated with the arc fault detector.

In addition, a variety of approaches may be used by the processor 110 to determine whether data from the sensor 108 regarding the electrical signal does or does not indicate the presence of an arc fault. One exemplary arrangement for processing data from the sensor 108 is described below.

As previously noted, the voltage and/or current waveforms typically exhibit distortions upon the occurrence of an arc fault. In an exemplary arrangement, these distortions are detected and are used for further processing.

The processor 110 tracks whether anomaly events are detected in each of a series of intervals.

For example, in an arc fault detector for an AC circuit it may be convenient to consider each AC cycle as a separate interval. The AC cycles represent discrete, consecutive time units, and are inherently present in an AC signal.

Given such an arrangement, a one-cycle time unit would be 1/50th of a second for a 50 Hz source current, 1/60th of a second for a 60 Hz source current, etc. However, this is exemplary only, and other time units or arrangements for determining time units, including but not limited to clock pulses, may be equally suitable. In particular, DC circuits, which lack AC cycles to use for timing purposes, may use other arrangements.

Moreover, it should be understood that an “interval” as the term is used herein is a logical unit, and is not limited to a particular physical unit. Thus, a group of two or more consecutive AC cycles might be considered to be a single interval.

For purposes of further discussion, it will be assumed that the time unit in question is a single AC cycle, although it is emphasized that this is exemplary only.

Depending on whether anomaly events are found in a cycle, and how many such anomaly events are present in the cycle, each individual cycle is classified as either being an event interval or a non-event interval (or simply a “non-event”).

In the exemplary arrangement under consideration, the determining factor is the presence and/or number of signal distortions—more generally, the number of anomaly events—that occur in a particular AC cycle. Some minimum number of anomaly events p must be detected in a given AC cycle in order for that cycle to be classified as an event interval.

For some embodiments, the minimum number of anomaly events p may be as low as 1. In that case, any cycle that exhibits distortion will be classified as an event interval. However, the value of p may be set to essentially any positive integer. Increasing the value of p may improve resistance to false alarms, while decreasing p may improve sensitivity to actual arc faults.

Although anomaly events are referred to herein for convenience as though they are discrete events, this may not necessarily be the case for all embodiments of the present invention. For example, if a single distorted waveform is considered as a whole, it may be seen to have varying degrees of distortion.

For certain embodiments, it may be suitable to simply consider the waveform to be distorted if it shows any evidence of distortion. In such a case, p might be a binary value, i.e. 1 if distortion is present, 0 if the waveform is not distorted.

However, for other embodiments it may be preferable to assign a value top based on the degree or even the type of the distortion.

For example, a distortion that reduces the peak value of the waveform by 25% might be considered to be a single “event”, so that p is 1 for that wave cycle, while a distortion that reduces the peak value of the waveform by 50% might be considered to be two events (i.e. the first drop of 25% is one event, the second drop of 25% is a second event, etc.), so that p is 2 for that wave cycle.

Alternatively, changes in different aspects of the waveform might be considered to be separate events. Thus, a waveform that exhibits for example both a change in peak value and a change in the pulse width might be considered to have a value of 2 for p, with two separate anomaly events.

Thus, p should not be considered to be limited only to events that are entirely discrete. The value of p also may be representative of various degrees of anomaly, including but not limited to the degree of waveform distortion.

Regardless of the precise manner in which p is determined, the classifications, either event interval or non-event, for a number m of consecutive cycles are stored by the processor 110. The stored classifications represent a moving history of the last m AC cycles, with the classification data for the oldest cycle being discarded when classification data for a new cycle is obtained.

The number m of cycle classifications that are stored is not particularly limited, so long as m is at least 1. However, increasing m may increase the confidence of a determination that an arc fault is present, since the data available for the determination increases with increasing m. In a preferred embodiment, the value of m is at least 8.

An arc fault condition is determined if, of the m stored cycle classifications, at least n of them are event intervals. For example, if m is 8 and n is 4, then an arc fault condition is determined if at any point 4 or more of the 8 stored classifications are event intervals.

The number n of event intervals that is necessary to determine an arc fault condition must be at least 1, and must be less than or equal to m. Aside from this, n is not particularly limited. However, increasing n may increase false alarm resistance. In a preferred embodiment, n is at least 2.

It is emphasized that although the m classifications are for m consecutive cycles, the n event intervals are not required to be consecutive in order for an arc fault condition to be determined. So long as n of the m classifications are event intervals, regardless of the order or arrangement of those event intervals, the requirements for making a determination of an arc fault condition are met.

In some embodiments, there may be a preferred relationship between m and n. For example, n may be equal to one half m, so that for m=8, n=4. Alternatively, n may be equal to some other fraction of m, such as one fourth or three fourths, so that for m=8, n=2 and n=6 respectively. As yet another alternative, n may be equal to m. However, each of these relationships is exemplary only.

For certain embodiments, one or more of m, n, and p may be adjustable. Thus, it may be possible to customize the settings to emphasize sensitivity, false alarm resistance, etc., in response to varying conditions, local laws or codes, personal preferences, and so forth.

Some such adjustable embodiments may be designed for factory adjustment only, while others may facilitate adjustment by end users, or even automatic adjustment by computers or other control systems.

However, all such arrangements are exemplary only.

In addition, other phenomena may be used, in place of or in conjunction with waveform distortion, in determining whether a given AC cycle/time unit is considered an event interval that may be indicative of the presence of an arc fault.

For example, anomaly events may be defined as distortion of the current waveform in conjunction with changes in the level of current.

As previously noted, in a real arc fault the current in the circuit 100, and consequently in the impedance 106, typically is of significant size when compared with the source current. By contrast, many noise signals have very small currents as compared with either the source current or a real arc fault current.

Thus, in some cases signal distortions may be ignored on the basis of the current flow when the distortion occurs. For example, the processor 110 may classify a particular AC cycle as being suggestive of arc faulting, i.e. being an event interval, only if it includes at least p distortion wherein the current also exceeds a threshold value t. In such an arrangement, distortions that do not correspond to a current of at least t would not be considered as counting towards the minimum value p. Lacking p distortion events with t current, AC cycles otherwise would be classified as non-events, regardless of how many total distortion events might be present.

The threshold value t may vary from embodiment to embodiment. For example, it may be selected based on the particulars of the circuit design, any predicted current values for actual arc faults and/or anticipated false alarm signals, the magnitude of the source current, etc.

In addition, in certain embodiments the threshold current t may be adjustable, for example by the manufacturer and/or the end user, so as to enable customization of the arc fault detection capabilities of a particular embodiment.

Moreover, more than one type of event may be considered an anomaly event. For example, certain embodiments of arc fault detectors may be sensitive to both distortion of the voltage waveform and distortion of the current waveform, so that the presence of either type of distortion may be considered an anomaly event.

Such an arrangement may be advantageous, in that it may be sensitive to the signatures of arc faults of several different types.

It is noted that sensing waveform distortion may be particularly useful in detecting so-called “guillotine damage”, wherein a straight, relatively rigid object places the conductors and/or the insulation thereon under stress. As may be expected from the term, one example would be a straight blade pressing down on an electrical cord. However, other arrangements, such as pressure from a rocking chair, a heavy box, etc. also can produce such stresses. Conventionally, arc faults resulting from guillotine-type damage can be difficult to detect, although as noted sensing voltage and/or current distortion in the present invention may reveal them.

The approaches described herein with regard to interpretation of voltage signals to detect arc faults are not necessarily limited to either the apparatus described herein for arc fault detection and protection, or to the overall methods described herein for arc fault detection and protection. That is, interpretation of a signal according the principles of the present invention may be performed as a stand-alone process, regardless of the devices and/or methods used to obtain the signal.

As previously described, an exemplary general arrangement for the present invention utilizes a moving history of m intervals that are evaluated to determine whether at least n of those intervals are event intervals, wherein each event interval has at least p valid anomaly events therein. This arrangement is described above specifically with regard to the use of an impedance 106 and a method of using the same. However, an approach in accordance with the principles of the present invention for interpreting the electrical signal may nevertheless be applicable even if the electrical signal is obtained without the use of a impedance 106 or a similar method.

Returning to the function of the processor 110, when the conditions as described are met—that is, a moving history of m intervals includes at least n event intervals, wherein each event interval has at least p valid anomaly events therein—the processor 110 generates an alarm signal.

The nature and destination of the alarm signal may vary depending on the particular embodiment of the present invention. For example, the alarm signal may include an electrical signal that activates a warning light, a logical signal that is recorded on a hard disk or other storage device, etc.

In particular, the alarm signal may be utilized in order to provide protection from arc faults, in addition to simply detecting them.

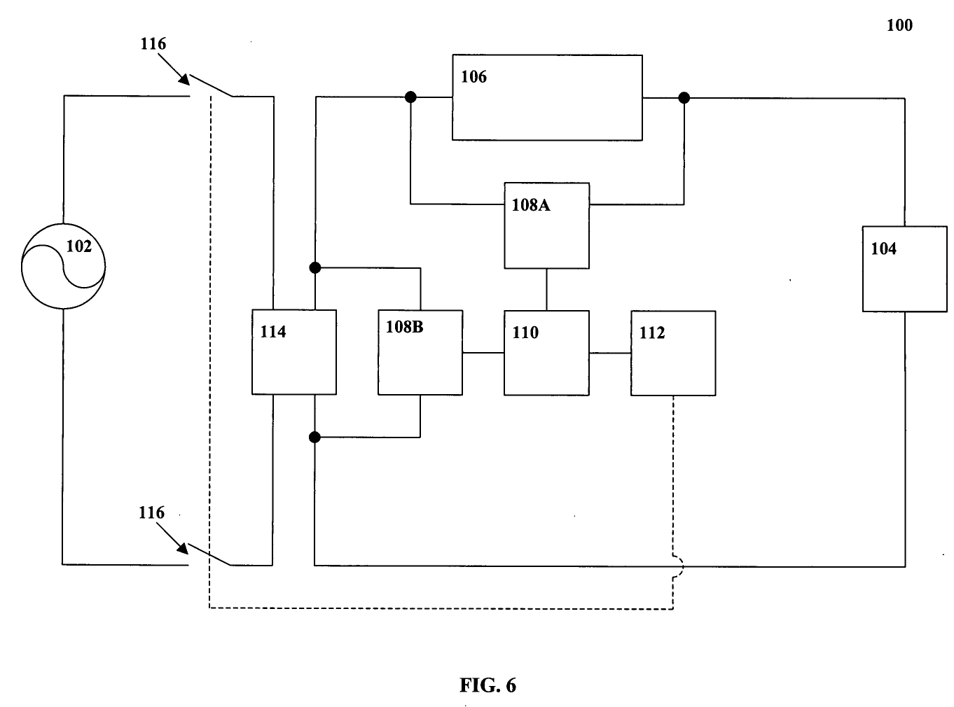

An exemplary embodiment of an apparatus for protecting a circuit from arc faults in accordance with the principles of the present invention is shown in FIG. 6. As illustrated therein, the circuit 100 includes a electrical source 102 and an electrical load 104. The circuit 100 also includes at least one sensor 108, and processor 110, similar in function and arrangement to those previously described with respect to FIG. 5. Also as shown in FIG. 5, the circuit 100 may include an impedance 106 to facilitate the operation of certain types of sensor 108.

In addition, the arc fault protector shown in FIG. 6 includes an actuator 112 in communication with the processor 110.

When an arc fault is identified, the processor 110 generates the alarm signal as previously indicated. The actuator 112 then performs some action to oppose the arc fault.

For example, as illustrated in FIG. 6, the actuator 112 is a circuit breaker. As shown, it is in communication with two switches 116, such that when an arc fault is detected, the actuator 112 opens the switches, breaking the circuit 100.

However, such an arrangement is exemplary only, and other approaches for opposing arc faults may be equally suitable.

In particular, the actuator 112 is not limited to only a single action. For example, in the arrangement shown in FIG. 6, the actuator 112 might break the circuit 100 and also activate a warning light (not shown) so as to identify the cause of the shut-off to the presence of an arc fault.

Circuit breakers and actuators are known per se, and are not further described herein.

Also of note in FIG. 6 is a power supply 114. In certain embodiments, the an arc fault detector/protector in accordance with the principles of the present invention may derive its power directly from the electrical source 102. However, other embodiments, such as that shown in FIG. 6, may include a separate power supply 114 that provides power to the various components of the arc fault detector/protector, and/or that acts as an intermediary in providing power to the load 104. The power supply 114 may be intermediate with the electrical source 102 as shown, so as to draw its own power therefrom and distribute power to the arc fault detector/protector. Alternatively, the power supply 114 may be entirely separate from the electrical source 102.

Power supplies are known per se, and are not further described herein.

It is noted that in both FIGS. 5 and 6, the impedance 106 is arranged in the same portion of the circuit 100. However, this is exemplary only. The impedance 106, if present, may be disposed substantially anywhere within the circuit, either “upstream” or “downstream” of the load 104.

Certain embodiments of the present invention may be suitable for use in retrofitting existing circuits.

For example, a kit for retrofitting a circuit 100 for arc fault detection includes at least one sensor 108 and a processor 110, each of which is previously described herein, and each of which may be arranged with respect to the circuit 100 and one another as previously described herein. The kit also may include an impedance 106, to facilitate the operation of certain types of sensor 108.

To provide arc protection, such a kit may also include an actuator 112, also as previously described.

In addition, a kit may include instructions for retrofitting the circuit 100 for arc fault detection/protection.

For example, for one exemplary embodiment the instructions may (in general terms) specify disposing at least one sensor 108 in communication with a circuit 100 so as to sense anomaly events therein, and disposing a processor 110 in communication with the sensor 108, the processor being adapted to identify those anomaly events and to generate an alarm signal if they are indicative of an arc fault. For kits including additional components, directions for arranging those components to provide the additional functionality of those components in an arc fault detector as described herein also may be included within the instructions.

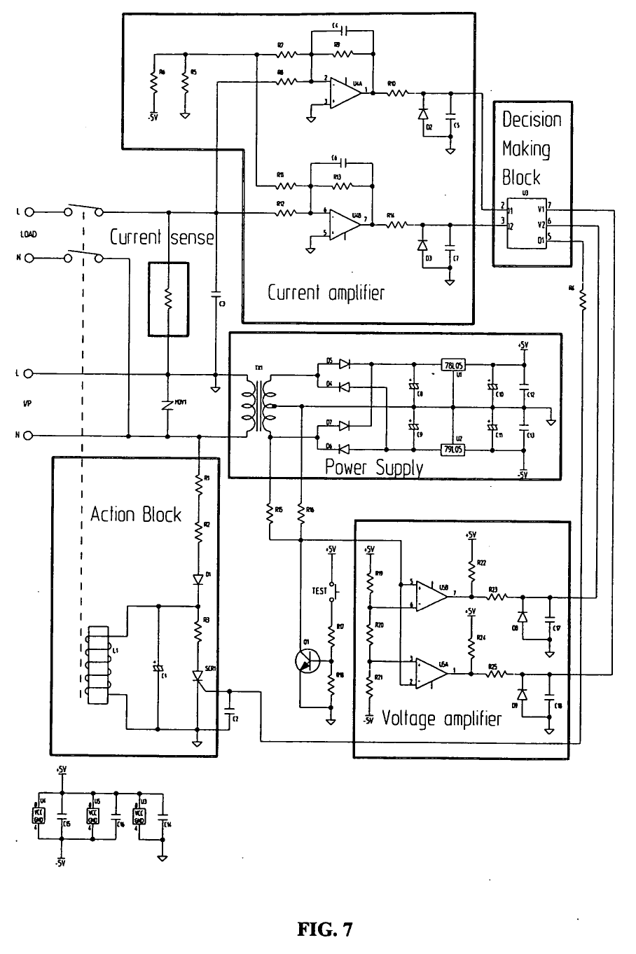

Arc fault detector/protectors are described herein primarily in general terms, essentially in block form. However, for illustrative purposes, FIG. 7 shows an exemplary circuit schematic for arc fault protection. It is emphasized that this arrangement is exemplary only, and that the present invention is not limited thereto. An arc fault detector/protector in accordance with the principles of the present invention may vary considerably in its design and construction.

In addition, the applications of an arc fault detector/protector in accordance with the principles of the present invention also may vary considerably.

For example, one exemplary apparatus for which an arc fault detector/protector in accordance with the principles of the present invention may be suitable is an air conditioner. Air conditioners commonly have relatively high power demands, and thus may be candidates for arc faulting.

However, this is exemplary only. The present invention is not limited only to use with air conditioners or related circuits.

The above specification, examples and data provide a complete description of the manufacture and use of the composition of the invention. Since many embodiments of the invention can be made without departing from the spirit and scope of the invention, the invention resides in the claims hereinafter appended.

1. An arc fault detector, comprising:
at least one sensor in communication with a circuit so as to sense anomaly events in an electrical signal in said circuit;
a processor in communication with said sensor so as to identify said anomaly events, said processor generating an alarm signal when said anomaly events are indicative of an arc fault in said circuit;
wherein said anomaly events comprise distortions of a waveform of said electrical signal.

2. The arc fault detector according to claim 1, wherein:
said at least one sensor comprises a voltage sensor in communication with said circuit so as to monitor a waveform of a voltage applied to said circuit;
wherein said anomaly events comprise distortions of said applied voltage waveform.

3. The arc fault detector according to claim 1, wherein:
said at least one sensor comprises a current sensor in communication with said circuit so as to monitor a waveform of a current applied to said circuit;
said anomaly events comprise distortion of said applied current waveform.

4. The arc fault detector according to claim 1, wherein:
said processor identifies said anomaly events during intervals of said electrical signal, classifies said intervals as event intervals if at least p anomaly events are identified during said intervals, p being a positive integer, and otherwise classifies said intervals as non-events;
said processor stores event classifications for m consecutive intervals, m being a positive integer; and
said processor generates said alarm signal if at least n of said m consecutive intervals are event intervals, n being a positive integer less than or equal to m.

5. The arc fault detector according to claim 4, wherein:
said circuit is an AC circuit, and said intervals comprise at least one AC cycle.

6. An arc fault protector, comprising:
an arc fault detector according to claim 1; and
an actuator in communication with said processor, said actuator opposing said arc fault in said circuit upon receiving said alarm signal.

7. The arc fault protector according to claim 6, wherein:
said actuator interrupts said circuit upon receiving said alarm signal.

8. The arc fault protector according to claim 6, wherein:
said actuator comprises a circuit breaker.

9. A kit for retrofitting a circuit for arc fault detection, comprising:
at least one sensor adapted to be arranged in communication with a circuit for sensing anomaly events in an electrical signal in said circuit;
a processor adapted to identify said anomaly events in said electrical signal, and to generate an alarm signal when said anomaly events are indicative of an arc fault in said circuit;
wherein said anomaly events comprise distortions of a waveform of said electrical signal.

10. The kit according to claim 9, wherein:
said at least one sensor comprises a voltage sensor adapted to be in communication with said circuit so as to monitor a waveform of a voltage applied to said circuit.

11. The kit according to claim 9, further comprising:
instructions for retrofitting said circuit.

12. A method of detecting an arc fault in a circuit, comprising:
sensing anomaly events in an electrical signal in said circuit;
interpreting said anomaly events to determine a presence of said arc fault in said circuit;
wherein said anomaly events comprise distortions of a waveform of said electrical signal.

13. The method according to claim 12, wherein:
said anomaly events comprise waveform distortions of a voltage applied to said circuit.

14. The method according to claim 12, wherein:
said anomaly events comprise waveform distortions of a current in said circuit.

15. The method according to claim 12, wherein:
interpreting said anomaly events comprises associating said anomaly events with intervals, classifying said intervals as event intervals if at least p anomaly events are identified during said intervals, p being a positive integer, and otherwise classifying said intervals as non-events;
storing event classifications for m consecutive intervals, m being a positive integer; and
generating said alarm signal if at least n of said m consecutive intervals are event intervals, n being a positive integer less than or equal to m.

16. The method according to claim 12, wherein:
said circuit is an AC circuit, and said intervals comprise at least one AC cycle.

17. A method of protecting a circuit from arc fault, comprising:
detecting an arc fault according to claim 12; and
opposing said arc fault in said circuit.

18. The method according to claim 17, wherein:
opposing said arc fault comprises interrupting said circuit.

19. A method of interpreting an electrical signal to detect an arc fault, comprising:
identifying anomaly events in said electrical signal during intervals;
for each of said intervals, classifying said interval as an event interval if at least p anomaly events are identified during said interval, p being a positive integer, otherwise classifying said interval as a non-event;
storing event classifications for m consecutive intervals, m being a positive integer; and
indicating an arc fault if at least n of said m consecutive intervals are event intervals, n being a positive integer less than or equal to m.
